(19) United States
(12) Patent Application Publication
(10) Pub. No.: US 2007/0192989 A1
(43) Pub. Date: Aug. 23, 2007

(54) Convex polyhedron-shaped doorstop

(76) Inventor: Yaron Farzan, Tel Aviv (IL)

Correspondence Address: YARON FARZAN, Shlomo Hamelekh 6, Tel Aviv, 64377, IL

(21) Appl. No.: 11/357,620

(22) Filed: Feb. 21, 2006

(51) Int. Cl. E05F 5/02

(52) U.S. Cl. 16/82

(57) ABSTRACT

The device of the present invention is a convex polyhedron-shaped doorstop.

### BACKGROUND

For centuries doorstops have been a part of our homes and offices. Doorstops come in many forms: wedge-shaped; stationary and mobile; attached to doors; bolted to floors; and in many other forms.

The wedge-shaped doorstop is by far the most visibly used. It offers a cheap solution. However, often, these wedge-shaped doorstops are found in a position that one has to manipulate it with one's foot in order to align it properly under the door. That is, to have the lower end of the wedge towards the space between the door and the floor. This can sometimes turn out to be a frustrating experience. The device of the present invention solves this problem. A convex polyhedron-shaped doorstop, especially one that is a tetrahedron, can stop a door at any position it is placed on the floor at any point in the door's path. The convex polyhedron-shaped doorstop restricts the movement of a door by sliding the door over at least one of its vertices.

In the preferred embodiment, the convex polyhedron is a regular, convex tetrahedron comprising cone-shaped vertices with friction rings. The vertices of the preferred embodiment meet and form a center.

The preferred embodiment of the present invention takes the form of a one-piece device that is easy to install, easy to use, easy to maintain, removable, transferrable, and cheap to produce.

This invention is useful wherever the movement of a door requires restriction.

A polyhedron is a solid bounded by polygons.

A polyhedron is:
Convex if the line segment joining any two points of the polyhedron is contained in the polyhedron's interior;
Vertex-uniform if all vertices are the same, in the sense that for any two vertices there exists a symmetry of the polyhedron mapping the first onto the second;
Edge-uniform if all edges are the same, in the sense that for any two edges there exists a symmetry of the polyhedron mapping the first onto the second;
Face-uniform if all faces are the same, in the sense that for any two faces there exists a symmetry of the polyhedron mapping the first onto the second;
Regular if it is vertex-uniform, edge-uniform and face-uniform;
Uniform if it is vertex-uniform and every face is a regular polygon. These are semiregular in the same way that the Archimedean solids are, but the faces and vertex figures need not be convex.

A tetrahedron is a polyhedron with four faces.

### SUMMARY OF THE INVENTION

The objective of the present invention is to restrict the movement of a door.

The preferred embodiment of the doorstop is a regular, convex tetrahederon, which, due to its shape, can function as a doorstop in any position. Rings that facilitate extra friction have been added onto the surface of the vertices of the preferred embodiment.

The device of the present invention can have a smooth or textured surface.

An advantage of a convex polyhedron-shaped doorstop that it is more child-safe than wedge-shaped doorstops. Of course, this is conditioned on the size of the doorstop.

The preferred material for the device of the present invention would be rubber, rubber silicon, any elastic material or any material that gives.

### BRIEF DESCRIPTION OF THE DRAWINGS

FIG. 1 is a general view of the first preferred embodiment.

FIG. 2 is top view of the first preferred embodiment.

FIG. 3 is a bottom view of the first preferred embodiment.

FIG. 4 is a side view of the first preferred embodiment.

FIG. 5 is a the opposite side view of the first preferred embodiment.

### DETAILED DESCRIPTION OF THE DRAWINGS

The following is an explanation based on the drawings of the preferred embodiment of this invention.

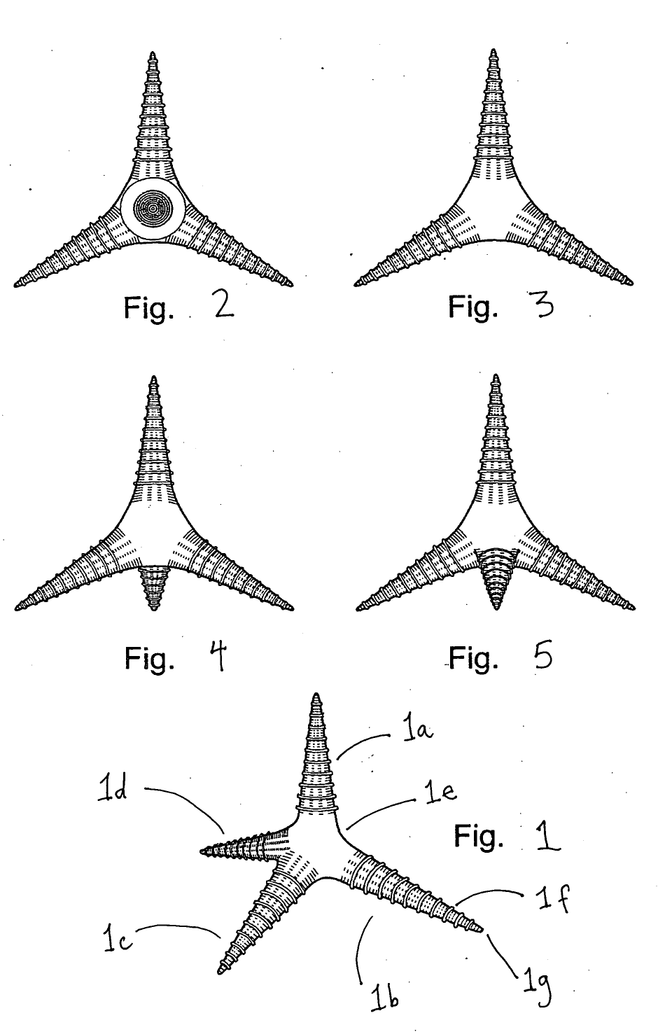

FIG. 1 shows a regular, convex tetrahedron. Cone-shaped vertices 1a, 1b, 1c and 1d meet to form center 1e. Rings if around the vertices add friction. The cone-shaped vertices are tapered to a fine point 1g to facilitate sliding under a door.

FIG. 2, as FIG. 1 shown from the top.

FIG. 3, as FIG. 1 shown from the bottom.

FIG. 4, as FIG. 1 shown from the side.

FIG. 5, as FIG. 1 shown from the other side.

### DESCRIPTION

A doorstop in the shape of a convex polyhedron. A doorstop in the shape of a convex polyhedron wherein the polyhedron is vertex-uniform. A doorstop in the shape of a convex polyhedron, wherein the polyhedron is not vertex-uniform. A doorstop in the shape of a convex polyhedron, wherein the polyhedron is edge-uniform. A doorstop in the shape of a convex polyhedron, wherein the polyhedron is not edge-uniform. A doorstop in the shape of a convex polyhedron, wherein the polyhedron is face-uniform. A doorstop in the shape of a convex polyhedron, wherein the polyhedron is not face-uniform. A doorstop in the shape of a convex polyhedron, wherein the polyhedron is regular. A doorstop in the shape of a convex polyhedron, wherein the polyhedron is not regular. A doorstop in the shape of a convex polyhedron, wherein the polyhedron is uniform. A doorstop in the shape of a convex polyhedron, wherein the polyhedron is not uniform.

A doorstop in the shape of a convex polyhedron, wherein the polyhedron is a tetrahedron.

A doorstop in the shape of a convex polyhedron, wherein at least one of the vertices of the convex polyhedron is shaped in any way as to have a point or a flat-tip or is cone-shaped or is polyhedron-shaped to facilitate easy sliding under a door.

What is claimed is:

1. A doorstop in the shape of a convex polyhedron.

2. A doorstop in the shape of a convex polyhedron as defined in claim 1, wherein the polyhedron is vertex-uniform.

3. A doorstop in the shape of a convex polyhedron as defined in claim 1, wherein the polyhedron is not vertex-uniform.

4. A doorstop in the shape of a convex polyhedron as defined in claim 1, wherein the polyhedron is edge-uniform.

5. A doorstop in the shape of a convex polyhedron as defined in claim 1, wherein the polyhedron is not edge-uniform.

6. A doorstop in the shape of a convex polyhedron as defined in claim 1, wherein the polyhedron is face-uniform.

7. A doorstop in the shape of a convex polyhedron as defined in claim 1, wherein the polyhedron is not face-uniform.

8. A doorstop in the shape of a convex polyhedron as defined in claim 1, wherein the polyhedron is regular.

9. A doorstop in the shape of a convex polyhedron as defined in claim 1, wherein the polyhedron is not regular.

10. A doorstop in the shape of a convex polyhedron as defined in claim 1, wherein the polyhedron is uniform.

11. A doorstop in the shape of a convex polyhedron as defined in claim 1, wherein the polyhedron is not uniform.

12. A doorstop in the shape of a convex polyhedron as defined in claim 1, wherein the polyhedron is a tetrahedron.

13. A doorstop in the shape of a convex polyhedron, as defined in claim 1, wherein at least one of the vertices of the convex polyhedron is shaped in any way as to have a point or a flat-tip or is cone-shaped or is polyhedron-shaped.
